(19) United States
(12) Patent Application Publication
(10) Pub. No.: US 2014/0052616 A1
(43) Pub. Date: Feb. 20, 2014

(54) PAYMENT SYSTEM AND METHODS FOR BROKERING CONSUMER-PAY TRANSACTIONS

(71) Applicant: Plastiq Inc., Boston, MA (US)

(72) Inventors: Daniel J. Choi, Sommerville, MA (US); Eliot L. Buchanan, Sommerville, MA (US)

(21) Appl. No.: 13/925,312

(22) Filed: Jun. 24, 2013

Related U.S. Application Data
(60) Provisional application No. 61/684,210, filed on Aug. 17, 2012.

(51) Int. Cl. G06Q 20/02

(52) U.S. Cl. CPC G06Q 20/02
USPC 705/39

(57) ABSTRACT

A payment management platform for brokering consumer-pay transactions is provided.

### CROSS-REFERENCE TO RELATED APPLICATION

The present application claims priority to U.S. Provisional Patent Application No. 61/684,210, filed Aug. 17, 2012, the disclosure of which is incorporated herein in its entirety.

### TECHNICAL FIELD

Embodiments of the invention relate generally to payment systems and, more specifically, to enabling a platform for brokering consumer-pay transactions.

### BACKGROUND

Merchants have long been at odds with credit card acceptance. Its advantages, namely streamlined collections and increased business, stand in stark contrast to major barriers like time-consuming technical implementations and complex fee structures levied by card associations and issuers. For many merchants, the business case for accepting credit cards simply cannot be substantiated. As a result, their consumers are forced to pursue alternative means of payment such as check, cash, or money order.

Enabling credit card usage at these merchants requires at minimum a shift of cost from the merchants to another party. The most popular solution, and by far the one with most traction, is the so-called “consumer-pay” model. The consumer-pay model involves charging consumers an extra fee for making payments on a credit card and typically takes one of two forms. The first involves merchants issuing consumers a surcharge to cover their transactional costs, while the second makes use of a third party that collects credit card payments plus fees directly from consumers and remits funds to merchants via check, ACH, or other funding mechanisms.

Both processes are not without inherent issues and inefficiencies. In addition to its dubious legality within the context of card association agreements, surcharging consumers is viewed by many merchants as an unacceptable practice. Though merchants understand the potential economic gains, a vast majority will abstain from surcharging for fear of losing business or angering their consumers. They adhere to a principle of charging identical prices for identical products or services rendered, independent from payment methods utilized. In addition, surcharging requires at least the technical capability to process credit cards, which is in and of itself a significant roadblock for many prospective card-accepting merchants.

To address many of these issues, some companies have inserted themselves as third parties to broker credit card payments to merchants on behalf of consumers. While this approach more closely adheres to card brand regulations and lessens the technical burden on merchants, it exposes the third party to an inordinate amount of risk. Aggregation requires the third party to serve as the merchant of record on credit card transactions, meaning that the third party alone appears on cardholder statements and is directly exposed to chargeback risk, should the cardholder deem the delivery of a product or service less than adequate. Additionally, the third party must manage more complex funding processes, which results in slower and less reliable funding when compared to standard merchant processor arrangements.

Neither surcharging nor third party aggregation effect a solution that optimally addresses cost, risk, and operational complexity. As such, an alternate solution for brokering payment transactions between consumers and merchants is desired.

### SUMMARY OF THE INVENTION

The present invention is directed at a payment management platform for brokering consumer-pay transactions.

Consumer-pay transactions, in which cardholders cover up to the full transactional costs of their payments, address the fundamental roadblock to merchant credit card acceptance by shifting costs away from merchants. In doing so, such transactions help satisfy cardholder demand for convenient payments on credit with consumer protection and rewards programs, and merchants can reap the benefits of accepting credit cards without paying the fees typically required to do so. Major stakeholders in the credit card industry also benefit—card associations, issuing banks, and acquirers continue to demand greater volume and credit card usage amidst a maturing industry landscape.

The present invention enables a consumer-pay model that features optimal assignment of cost and risk—cost primarily to the cardholder and risk primarily to the merchant—with minimal operational complexity, all while adhering to industry and governmental regulations. The consumer-pay model of the present invention may employ a dual-MID approach, wherein two unique payment processing accounts (“MIDs”) are leveraged for a single consumer-pay transaction. In other words, two separate transactions to two distinct beneficiaries may be generated within the context of a single payment. This approach works primarily to assign charges to parties of de facto responsibility, which enables a consumer-pay model adhering to regulations, control chargeback and other risks, and reduces the operational burden of payment management and funding.

Embodiments of the present invention for brokering consumer-pay transactions are described in detail herein.

### BRIEF DESCRIPTION OF THE DRAWINGS

The present invention is illustrated by way of example, and not by way of limitation, and will become apparent upon consideration of the following detailed description, taken in conjunction with the accompanying drawings, in which like reference characters refer to like parts throughout, and in which:

FIG. 1 is a block diagram illustrating an exemplary computer network in which embodiments of the present invention may operate.

FIGS. 2A and 2B are block diagrams illustrating exemplary processing modules and components embodied in computer network elements of FIG. 1.

FIG. 3 is a flow diagram illustrating an embodiment of a method for a conducting a payment transaction.

FIG. 4 is a flow diagram illustrating an embodiment of a method for calculating a platform fee associated with the payment transaction.

FIG. 5 is a flow diagram illustrating an embodiment of a method for generating a dual-MID transaction associated with the payment transaction.

FIG. 6 illustrates a diagrammatic representation of a machine in the exemplary form of a computer system.

### DETAILED DESCRIPTION

In the following description, numerous details are set forth. It will be apparent, however, to one skilled in the art that the present invention may be practiced without these specific details. In some instances, well-known structures and devices are shown in block diagram form, rather than in detail, in order to avoid obscuring the present invention.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “receiving”, “identifying”, “selecting”, “retrieving”, “storing”, “registering”, “calculating”, “executing”, “acquiring”, “generating”, “transmitting”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

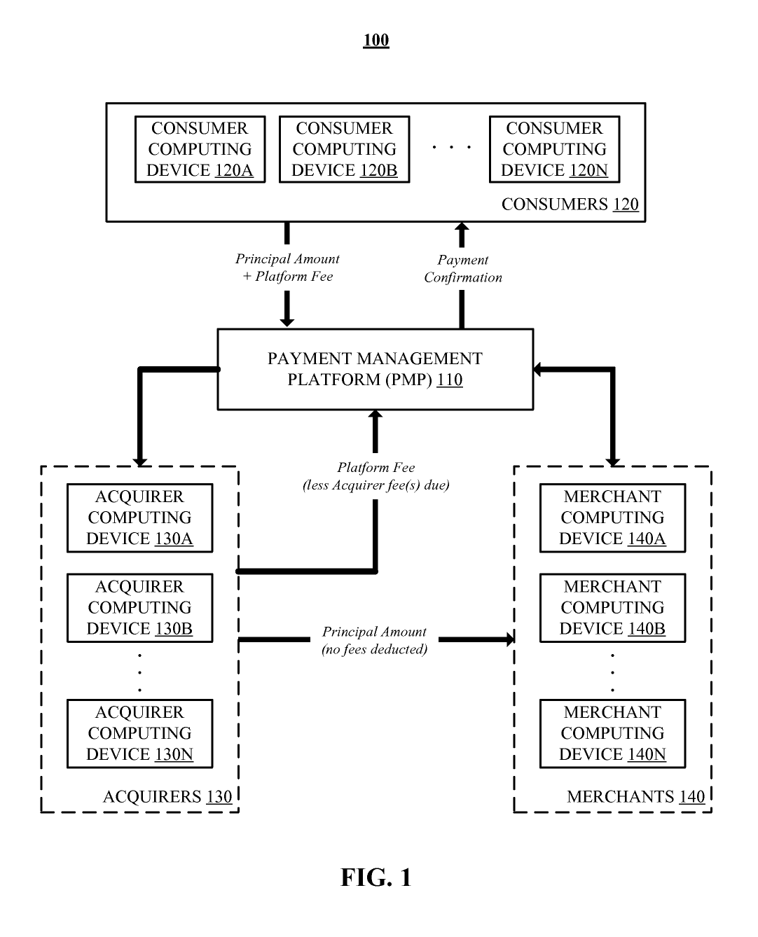

FIG. 1 is a block diagram illustrating an exemplary computer network 100 in which embodiments of the present invention may operate. Referring to FIG. 1, computer network 100 may be comprised of a payment management platform (PMP) 110, a plurality of consumer computing devices 120A-120N associated with consumers 120, a plurality of acquirer computing devices 130A-130N associated with acquirers 130 and a plurality of merchant computing devices 140A-140N associated with merchants 140. Computing devices associated with consumers 120, acquirers 130 and merchants 140 may be communicatively coupled to PMP 110 via a computer network. The computer network may be a private network (e.g., a local area network (LAN), wide area network (WAN), intranet, etc.) or a public network (e.g., the Internet).

Computer network 100, as illustrated in FIG. 1, provides one possible arrangement of representative entities that may be involved in processing a payment transaction in accordance with embodiments of the present invention. It should be noted that computer network 100 is not limited to the arrangement of representative entities illustrated in FIG. 1 and may be adapted to accommodate other embodiments well within the scope of the present invention. For example, the integration of acquirers 130 in computer network 100 may be an arrangement employed in one or more embodiments of the present invention that rely on the use of the credit cards as a preferred payment method for processing a payment transaction. However, acquirers 130 may be substituted or modified by other representative entities that are associated with processing of a payment transaction involving one or more alternate payment methods.

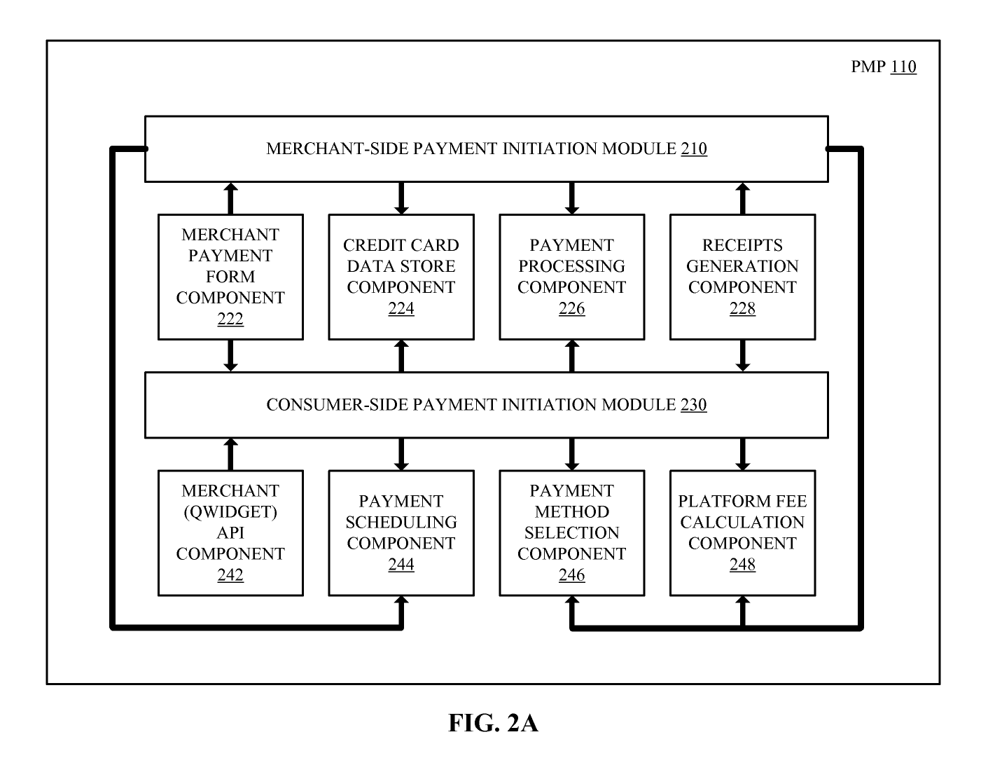

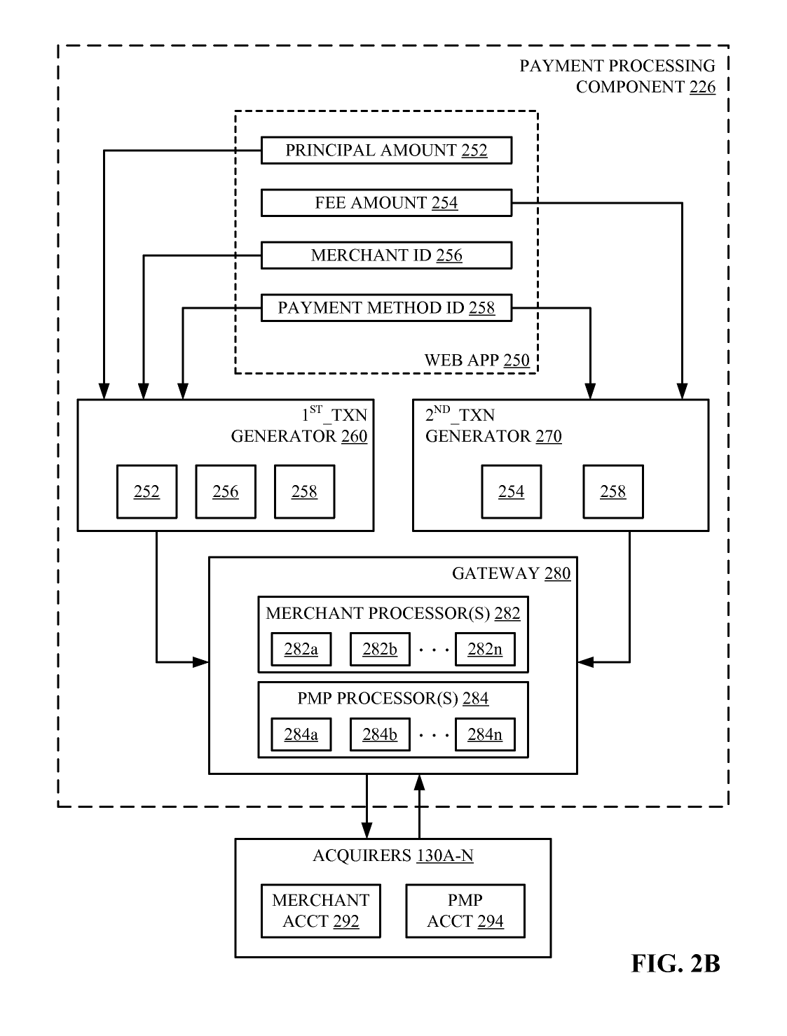

FIGS. 2A and 2B are block diagrams illustrating modules and components of PMP 110, in accordance with embodiments of the present invention. PMP 110 may be comprised of a merchant-side payment initiation module 210 and a consumer-side payment initiation module 230 for handling, respectively, a payment transaction initiated from merchant computing devices 140A-140N and consumer computing devices 120A-120N. To provide support and process requests received from module 210 and module 230, PMP 110 may be further comprised of a merchant payment form component 222, a credit card data store component 224, a payment processing component 226, a receipts generation component 228, a merchant API component 242, a payment scheduling component 244, a payment method selection component 246 and a platform fee calculation component 248.

Referring to FIG. 2A, merchant-side payment initiation module 210 may be communicatively coupled to merchant payment form component 222, credit card data store component 224, payment processing component 226, receipts generation component 228, payment scheduling component 244, payment method selection component 246 and platform fee calculation component 248. Similarly, consumer-side payment initiation module 230 may be communicatively coupled to components 222, 224, 226, 228, 244, 246, 248 and, additionally, to merchant API component 242.

Merchant payment form component 222 may be configured to enable merchants 140 to specify the various types of payments they are willing to accept via PMP 110. For each payment type identified, a merchant can specify a payment form with various attributes and fields required for transacting a credit card payment with the merchant. Thereafter, when a payment transaction is engaged either via merchant-side payment initiation module 210 or consumer-side payment initiation module 230, merchant payment form component 222 may be configured to present the payment form specified by the merchant to the consumer. The payment form may be dynamically loaded, wherein data received into the payment form from the consumer may be securely stored and listed along with the payment details upon submission.

When a consumer elects to initiate a payment transaction, via consumer-side initiated payment module 230, the consumer may do so directly through a user payment interface associated with PMP 110, or indirectly through a merchant's user payment interface enabled, for example, by merchant API component 242 of PMP 110. An initiated payment transaction may be an immediate payment or a scheduled payment. Payment scheduling component 244 may be configured to process requests for scheduling a payment. In one embodiment, a scheduled payment may be a custom one—time future payment to a merchant. In another embodiment, a scheduled payment may be a recurring payment to a merchant that is executed on specified dates.

A merchant selection page may be presented to the consumer, when the user payment interface of PMP 110 is engaged directly, to permit the consumer to search for a desired merchant. The merchant selection page may be configured, for example, to enable a consumer to conduct a search using a merchant's characteristics, affiliations or a combination thereof. The results yielded by the search may be sorted based on relevancy to the search criteria provided. Upon selection of a merchant, a merchant form information page may be presented to the consumer. The merchant form information page may be presented to the consumer, for example, if the merchant has previously specified active payment types. For example, a merchant may be a university that has set up multiple payment types including, but not limited to, payment of student tuition for a particular semester, student housing and a student meal plan.

Depending on the payment type selected, different attributes and fields may be presented on a payment form to solicit information from the consumer. On submission of the payment form, consumer data may be passed to a third party service for processing or validation, and a response may be sent back which affects payment. For example, a student may enter her student ID into a payment form, and that student ID may be validated by a request to the university's web services prior to continuing the payment process. As previously described, the attributes and fields presented on a payment form for a particular payment type may have been previously defined by a merchant via merchant payment form component 222.

Once a merchant and corresponding payment type are selected, payment methods may be solicited, in the case a consumer is not an existing account holder or is using a new payment method, or previously stored payment methods may be retrieved and presented, in the case a consumer is an existing account holder. For example, if the consumer is a non-account holder or is an existing account holder using a new credit card for conducting a payment transaction, data associated with the credit card may be temporarily stored in memory, via credit card data store component 224, for the duration of the payment transaction. Alternatively, if the consumer is an existing account holder, stored credit card data associated with the consumer's account may be retrieved from memory, via credit card data store component 224, and presented to a consumer for selection, via payment method selection component 246. For purposes of clarity, and not by way of limitation, payment methods are described herein with reference to credit cards. However, it is envisioned that a plurality of payment methods may be used, including but not limited to credit cards, debit cards, pre-paid cards, charge cards, ACH transfers, alternative electronic currencies, constructed payment programs, or any other type of card or card-less based method of payment.

If requested by the consumer, at least some of the temporarily stored credit card data may be stored in association with an account registered to the consumer for future transactions. When storing a new payment method in association with an account, identifying a corresponding payment channel and payment processor for conducting the payment transaction with the merchant may be managed by credit card data store component 224. At this time, other processes may be executed, including but not limited to matching of card data to an issuing bank via bank identification number (BIN) search, preauthorization or other verification techniques, collection and storage of billing address information, and tokenization of credit card data.

The term “payment channel” may refer to an entity or technology by which payments are made. Examples include MasterCard credit cards, Visa debit cards, or ACH transfers. The term “payment method” may refer to a specific and individual instance within a payment channel. Examples include John Smith's MasterCard or Jane Doe's Visa. Each payment channel and, by reduction, each payment method corresponds to a payment processor. The term “payment processor” may refer to an entity or technology equipped to transfer payments using payment methods via one or more payment channels.

When retrieving and presenting previously stored credit card payment methods for use in a payment transaction with a selected merchant, payment method selection component 246 may be configured to determine the payment processors that are active for the selected merchant, identify their corresponding payment channels and identify to a consumer engaging in the payment transaction only the credit card payment methods corresponding to the identified payment channels that are permissible for use in connection with the selected merchant. Payment method selection component 246 may also be configured to provide information about relevant payment methods, including but not limited to payment history and payment schedules, issuer or originator information, and verification details.

In one embodiment, data relating to a consumer, their selected payment methods for use in conducting payment transactions, their purchasing history and habits, and their merchant or group associations may be collected and stored. The stored data may be used to determine patterns and trends, generate usage statistics, provide advanced reporting to merchants and other parties, or leverage partnerships with organizations that may derive value from either the data itself or access to the consumer base that generated it. Such an embodiment may also utilize stored data for internal programs that seek to affect consumer behavior, potentially via points programs or other social or economic means.

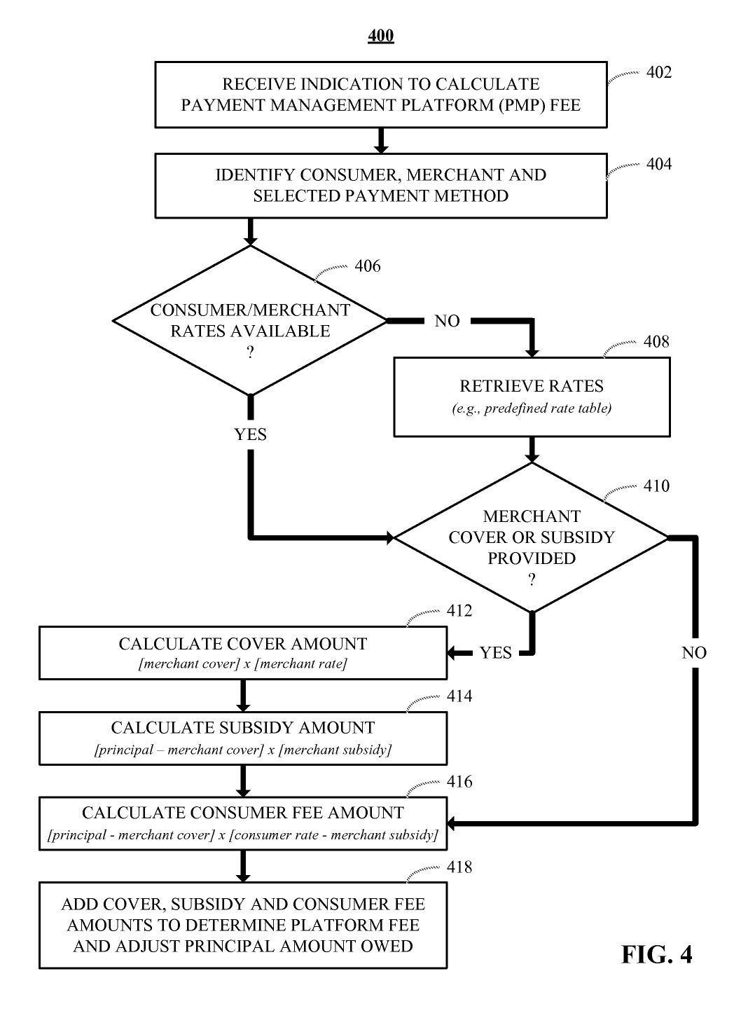

After a credit card payment method is identified for use in a payment transaction, a platform fee associated with the payment transaction may be calculated using platform fee calculation component 248. Platform fee calculation component 248 may be configured to encode and identify rates on a consumer level and a merchant level based on one or more criteria of the payment transaction (e.g., the principal amount owed to the merchant, the credit card payment method selected, the merchant selected, etc.). The use of rates in calculating the platform fee is described in further detail with reference to the process flow of FIG. 4.

A total amount for a payment transaction is comprised of the principal amount and the platform fee. After the total amount for the payment transaction is determined, it can be submitted for processing by payment processing component 226. Payment processing component 226 may be configured to generate and process all transactions types associated with the payment transaction. In the present invention, there may be at least two transaction types. A first transaction type may be associated solely with processing the principal amount to be transferred to an acquirer associated with the merchant. A second transaction type may be associated with processing the platform fee, should the platform fee calculated be greater than zero, to be transferred to an acquirer associated with an operator of PMP 110. Accordingly, the first and second transaction types, collectively referred to herein as a dual-MID transaction, correspond to two separate transactions—one for processing a payment to the merchant and one for processing a payment to the operator of PMP 110. The dual-MID transaction is an atomic process, in that a failure of the second transaction would result in a rollback of the first transaction, so as to cancel the entire payment transaction.

Various data points relating to a payment transaction may be used by payment processing component 226 in generating the dual-MID transaction. Referring to FIG. 2B, data points pertaining to a principal amount 252, a platform fee amount 254, a merchant ID 256 and a payment method ID 258 may be determined based on information provided by a consumer via a user payment interface accessed, for example, through a web application 250. Payment processing component 226 may be configured to retrieve principal amount 252, platform fee amount 254, merchant ID 256 and payment method ID 258 and forward the data retrieved to a first transaction generator 260 and a second transaction generator 270, as needed, for generating the dual-MID transaction needed to complete processing of the payment transaction.

First transaction generator 260 is associated with the first transaction type and may be configured to receive the data points comprising at least principal amount 252, merchant ID 256 and payment method ID 258. Second transaction generator 270 is associated with the second transaction type and may be configured to receive the data points comprising at least platform fee amount 254 and payment method ID 258. The first and second transaction types generated, respectively, by first transaction generator 260 and second transaction generator 270 may then be transmitted to a gateway 280 for processing of the corresponding principal amount and the platform fee.

Gateway 280 may be configured with processor scripts enabled by merchant processors 282 and PMP processors 284 that provide, respectively, a plurality of processors 282a-282n and 284a-284n. Processors 282a-282n may allow for processing of a principal amount of a payment transaction based on any one of the plurality of possible payment methods for any one of a plurality of merchants. Processors 284a-284n may allow for processing of a platform fee of a payment transaction based on any one of the plurality of possible payment methods.

When processing the principal amount of a payment transaction, the selected payment method, the selected merchant, other applicable criteria or a combination thereof may determine which particular processor from the plurality of processors 282a-282n of merchant processors 282 is used. For example, processor 282a may be used to process the principal amount of the payment transaction where a consumer utilized a MasterCard credit card (the payment method) for payment of tuition to New York University (the merchant), while processor 282b may be used to process the principal amount of the payment transaction where the consumer utilized an AMEX credit card for payment to the same merchant. Once first and second transaction types for a payment transaction are processed by the appropriate processors 282a-282n and 284a-284n, funds associated with the first transaction type relating to the principal amount and the second transaction type relating to the platform fee may be transferred to corresponding acquirers 130A-130N holding, respectively, the corresponding merchant account 292 and PMP account 294.

Confirmations that a payment transaction has been successfully processed may be provided via receipts generation component 228. Confirmations may be generated and transmitted to a consumer, a merchant or both depending on several factors. Factors that may be considered by receipts generation component 228 in determining the confirmation to be transmitted include, but are not limited to, whether the payment transaction originated from merchant-initiated payment module 210 or consumer-initiated payment module 230, whether the payment transaction is an immediate, scheduled or recurring payment, and the type of action (e.g., authorization, capture, reversal of funds, etc.) that is being taken in connection with the payment transaction.

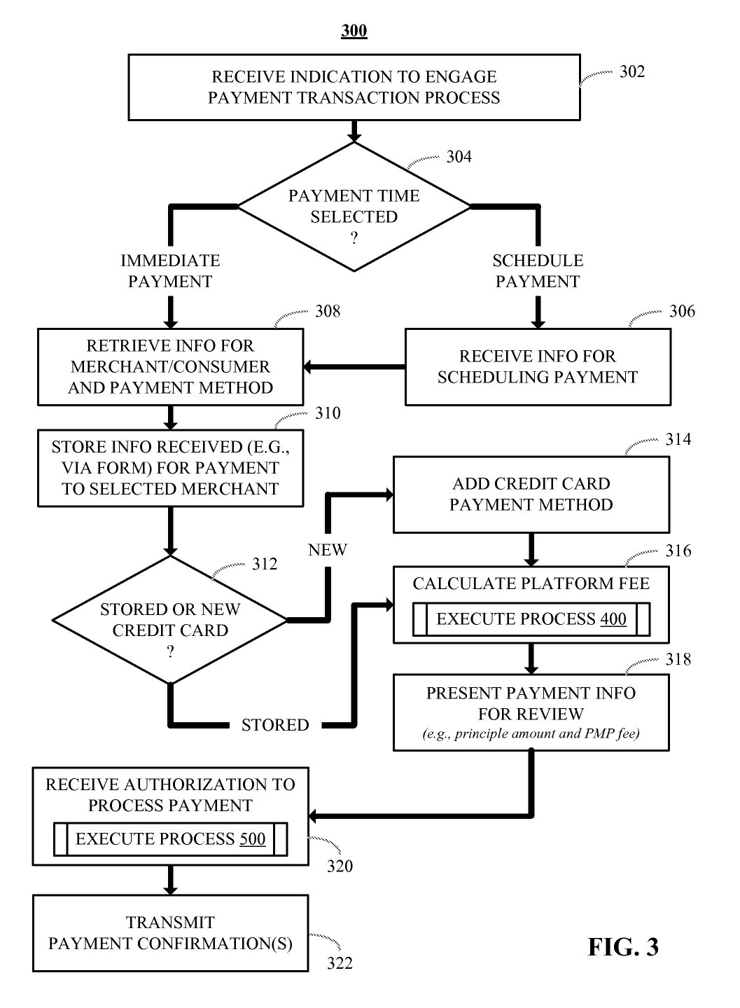

Those skilled in the art will appreciate that PMP 110 may be configured with more or less modules and components to conduct the methods described herein with reference to FIGS. 3-5. As illustrated in FIGS. 3-5, each of corresponding methods 300, 400 and 500 may be performed by processing logic that may comprise hardware (e.g., circuitry, dedicated logic, programmable logic, microcode, etc.), software (such as instructions run on a processing device), or a combination thereof.

FIG. 3 is a flow diagram illustrating a method 300 for conducting a payment transaction, according to an embodiment of the invention. Referring to FIG. 3, method 300 may be initiated upon receiving, at block 302, an indication to engage in a payment transaction process either via merchant-initiated payment module 210 or consumer-initiated payment module 230 of PMP 110.

A determination may be made, at block 304, whether the timing of the payment transaction is for an immediate payment or a scheduled payment. If the payment transaction is to occur at a future point in time, information for scheduling the payment transaction may be received, at block 306, to allow automatic initiation of the payment transaction for a one-time future payment or a recurring payment via payment scheduling component 244 of PMP 110. Information for scheduling the payment transaction may comprise, for example, time, date, amount, sender and recipient, and frequency (if recurring) of the payment transaction.

In one embodiment, when a payment transaction is conducted via consumer-initiated payment module 230, information relating to a merchant and a consumer's available payment methods may be retrieved, at block 308. Information retrieved for the payment transaction may be stored, at block 310, to maintain, for example, a payment history between the consumer and the merchant. The consumer may conduct a search for a merchant and, upon identifying and selecting the desired merchant, information relating to the merchant may be retrieved for use in conducting the payment transaction.

In another embodiment, when a payment transaction is conducted via merchant-initiated payment module 210, information relating to a consumer and the consumer's available payment methods may be retrieved, at block 308. A merchant may conduct a search for the consumer and, upon identifying and selecting the desired consumer, information relating to the consumer may be retrieved for use in conducting the payment transaction.

In yet another embodiment, a merchant may configure one or more payment notifications to be transmitted to a consumer, via merchant-initiated payment module 210, wherein the notifications may facilitate a means to initiate one or more payment transactions, whether by hyperlinks, access codes, or other encodings. When the consumer utilizes one such encoding to initiate a payment transaction, the payment may be processed as if the consumer had initiated the payment transaction via consumer-initiated payment module 230. Merchant-configured notifications may store information regarding the payment transaction for pre-populated corresponding required fields, as presented via consumer-initiated payment module 230, such that the consumer may only have to specify payment method information to complete the payment transaction. Conversely, the payment notification may conceivably originate from the consumer within the consumer-initiated payment module 230 and be transmitted to the merchant to complete via the merchant-initiated payment module 210.

After the merchant and the consumer to the payment transaction are identified, whether via consumer-initiated payment module 230 or merchant-initiated payment module 210, a determination may be made, at block 312, whether the consumer's payment method to be used is a previously stored or new credit card payment method. If the payment method is new, the credit card may be added, at block 314, in association with the consumer's registered account for future use with the same, or a different, merchant. When the merchant and the consumer to the payment transaction are identified and the desired payment method is selected, the platform fee associated with conducting the payment transaction may be calculated, at block 316, using platform fee calculation component 248, as previously described with reference to FIG. 2A.

FIG. 4 is a flow diagram illustrating a method 400 for calculating a platform fee associated with the payment transaction, according to an embodiment of the invention. Referring to FIG. 4, method 400 may be initiated upon receiving, at block 402, an indication to engage in calculation of a platform fee. The consumer, the merchant and the payment method selected may be identified, at block 404, and used to determine, at block 406, whether there any associated consumer or merchant rates. A consumer rate may be a percentage or fixed fee applied to the principal amount to determine the platform fee paid by a consumer for conducting the payment transaction, while a merchant rate may be a percentage or fixed fee applied to the principal amount to determine the platform fee paid by a merchant for conducting the payment transaction.

The consumer rate and the merchant rate may be the same. However, in a preferred embodiment, the merchant rate is almost always lower than the consumer rate to incentivize merchants to cover more of the fees for their consumers. When a consumer is covering the full cost of the platform fee, the merchant rate is not used. Consumer and merchant rates may be defined, for example, based on the payment history of a consumer, the business type associated with the merchant, the principal amount owed to the merchant, the credit card payment method selected, other applicable criteria relevant to the determination of rates, or any combination thereof. If consumer and merchant rates are not available, then rates may be retrieved (e.g., by cross-referencing a pre-defined rate table), at block 408, based on one or more criteria (e.g., the payment method selected) for the payment transaction.

After consumer and merchant rates are identified, a determination may be made, at block 410, to identify whether a merchant has provided for a cover or a subsidy in connection with the payment transaction, wherein a merchant specified cover and subsidy may be used in calculating the platform fee. A merchant cover is a maximum amount on which the merchant is willing to cover the platform fee. To calculate a cover amount given a specified merchant cover, at block 412, the minimum of the specified merchant cover or the principal amount owed is multiplied by the previously identified merchant rate. A merchant subsidy is a percentage amount that the merchant is willing to pay for accepting credit cards. To calculate a subsidy amount given a specified merchant subsidy, at block 414, the specified merchant cover is subtracted from the principal amount owed (only in cases where the principal amount owed is greater than the specified merchant cover) and the resulting difference is multiplied by the specified merchant subsidy.

Having calculated the cover amount and the subsidy amount, a consumer fee amount may then be calculated, at block 416, by calculating a first value comprising subtracting the specified merchant cover from the principal amount owed, calculating a second value comprising subtracting the specified merchant subsidy from the consumer rate, and multiplying the first value and second value. If a merchant cover or a merchant subsidy is not provided, then method 400 may proceed directly to calculating the consumer fee amount, at block 416, which would be the principal amount owed multiplied by the consumer rate. In this case, the consumer fee amount is the platform fee (since there are no adjustments made due to a zero merchant cover or subsidy).

An example scenario for calculating a platform fee employing method 400 is provided as follows. In the example, a consumer engages PMP 110 to effectuate a payment transaction, wherein the consumer has elected to use a credit card to pay a tuition of $10,000 (the original principal amount) to State University (the merchant), and wherein a consumer rate of 2% and a merchant rate of 1.5% is identified in connection with the payment transaction. Additionally, a cover of fees up to $1000 and a subsidy of 1% are specified by the merchant in connection with the payment transaction.

Using the values provided in the example scenario, method 400 may first calculate a cover amount, at block 412, given the specified merchant cover of $1000. The cover amount is calculated by first identifying the minimum of the specified merchant cover and the original principal amount, which in this scenario is the specified merchant cover ($1000). The specified merchant cover ($1000) is then multiplied by the merchant rate (1.5% or 0.015), resulting in a cover amount equal to $15. Where the original principal amount is greater than the specified merchant cover, the subsidy amount may then be calculated by subtracting the specified merchant cover ($1000) from the original principal amount ($10,000) and multiplying the difference by specified merchant subsidy (1% or 0.010), resulting in a subsidy amount equal to $90. The consumer fee amount, independent of the calculated cover and subsidy amounts, may then be calculated by subtracting the specified merchant cover ($1000) from the original principal amount ($10,000), yielding a first difference value of $9,000, and subtracting the specified merchant subsidy (1% or 0.010) from the consumer rate (2% or 0.020), yielding a second difference value of 1% or 0.010, wherein the first difference value ($9,000) is multiplied by the second difference value (0.010) to result in a consumer fee amount equal to $90.

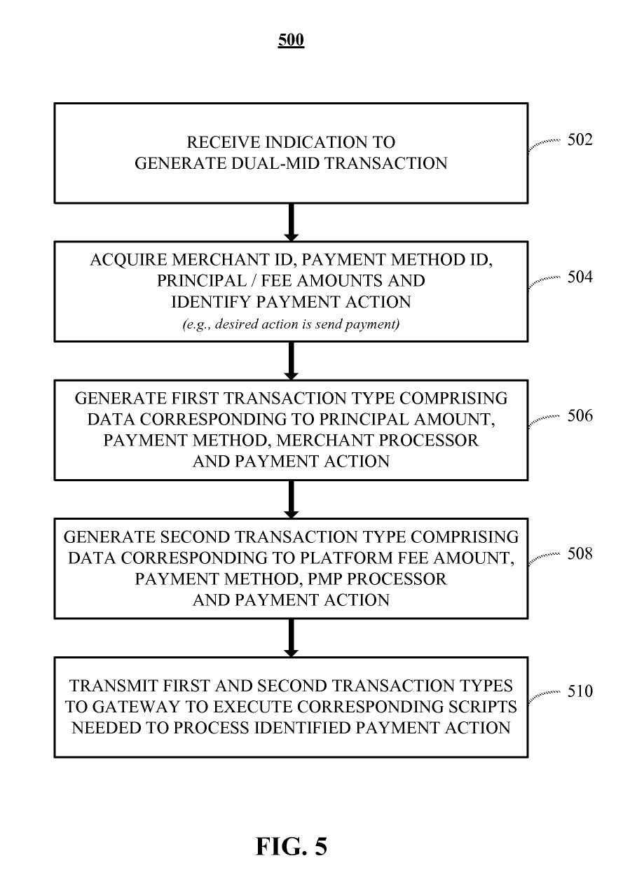

The original principal amount ($10,000) is adjusted by subtracting the calculated cover amount ($15) and the calculated subsidy amount ($90), making the adjusted principal amount due by the consumer equal to $9,895. In addition to the adjusted principal amount due, the platform fee owed for the payment transaction is the total of the calculated cover amount ($15), the calculated subsidy amount ($90) and the calculated consumer fee amount ($90), making the platform fee due by the consumer equal to $195. Thus the total payment (principal+platform fee) due from the consumer is $10,090. In accordance with a preferred embodiment of the present invention, the total payment due from the consumer may be processed across two separate transactions (i.e., a transaction representative of the principal and a transaction representative of the platform fee) using the dual-MID approach, as described with reference to method 500 of FIG. 5.

Note that the calculated cover and subsidy amounts subtracted from the original principal amount are added to the calculated consumer fee amount to avoid having to settle with the merchant separately after the payment transaction for the cover and subsidy amounts. More importantly, the consumer pays less overall when compared to a platform fee calculation without a merchant provided cover and subsidy. Absent the merchant provided cover and subsidy in the example scenario, the platform fee would be the original principal amount ($10,000) multiplied by the consumer rate (2% or 0.020), resulting in a platform fee of $200 and a total payment due from the consumer of $10,200.

Once the cover amount, subsidy amount and consumer fee amount have been calculated, and the three amounts are added together to yield the platform fee, the total charge to be incurred (i.e., the principal amount and corresponding platform fee) may be calculated, at block 418, and presented, at block 318, to the consumer for review prior to authorizing processing of the total charge. The total charge associated with the payment transaction may be processed when authorization is received, at block 320, by payment processing component 226 of PMP 110 (FIG. 2A). In processing the total charge associated with the payment transaction, payment processing component 226 may be configured to execute the dual-MID transaction.

FIG. 5 is a flow diagram illustrating a method 500 for generating a dual-MID transaction. Referring to FIG. 5, method 500 may be initiated upon receiving, at block 502, an indication to generate the dual-MID transaction. Upon receiving the indication, the merchant ID, the payment method ID, the principal amount owed to the merchant, the platform fee owed to the PMP operator and identification of the payment action associated with the payment transaction being processed may be acquired, at block 504, to generate a two-part transaction comprising a first transaction type, at block 506, and a second transaction type, at block 508. The first transaction generated, at block 506, comprises at least data corresponding to the principal amount, the payment method, the merchant processor and the payment action. The second transaction generated, at block 508, comprises at least data corresponding to the platform fee amount, the payment method, the PMP processor and the payment action.

The process of generating the dual-MID transaction gains special importance within the context of the credit card payments industry in that the first and second transactions are routed to two distinct merchants of record (i.e., the merchant and the PMP operator) and, as a result, the two distinct merchants of record each transact directly with the cardholder (i.e., the consumer) via PMP 110 and retain standard merchant responsibilities over their respective payments—namely exposure to chargeback risk, visibility on the cardholder statement, and direct funding from an acquirer partner. Assigning responsibility in this manner enables a consumer-pay model minimizing operational cost and risk, while maximizing efficiency and scalability. In one embodiment, in order to fully relieve merchants of the transactional costs of credit card acceptance, the PMP operator may either settle funds independently with the merchant post completion of the payment transaction or, ideally, negotiate with the acquirer to bill all fees for the merchant's account to that of the PMP operator.

Once generated, the two transactions may be transmitted to a gateway (see FIG. 2B) configured to execute, at block 510, corresponding scripts based on the data received in connection with each transaction. The principal amount represented by the first transaction and the platform fee represented by the second transaction may then be transferred to acquirers 130A-130N holding accounts associated with, respectively, the merchant and PMP. Thereafter, one or more confirmations may be transmitted, at block 322, to the consumer, merchant or both (depending on consumer or merchant preferences or predefined settings and the action type) related to processing of the payment transaction.

It should be noted that the sequence of operations described in conjunction with methods 300, 400 and 500 may be different from that illustrated, respectively, in corresponding FIGS. 3, 4 and 5. For example, the operations associated with blocks 304 and 306, as illustrated in method 300 of FIG. 3, may be executed after the operations at blocks 308-316. It should also be noted that an additional sequence of operations associated with other embodiments of a payment transaction may be incorporated into methods 300, 400 and 500. For example, embodiments directed at an early payment model, an acquirer as merchant of record model, a third-party payment or subsidy model, a non-partner merchant funding model, a delayed merchant settlement model or any combination thereof may be incorporated into methods 300, 400 and 500 and are within the spirit and scope of the present invention.

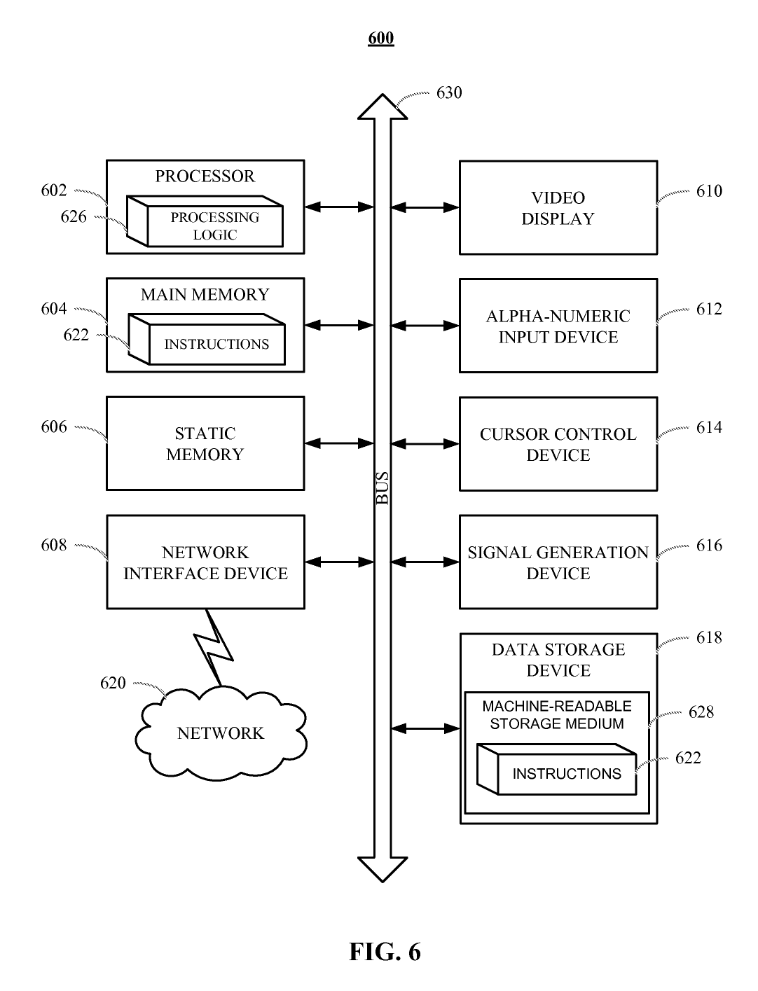

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 may be comprised of a processing device 602, a main memory 604 (e.g., read-only memory (ROM), flash memory, dynamic random access memory (DRAM) (such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute processing logic 626 for performing the operations and steps discussed herein.

Computer system 600 may further include a network interface device 608. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

Data storage device 618 may include a machine-readable storage medium (or more specifically a computer-readable storage medium) 628 having one or more sets of instructions (e.g., software 622) embodying any one or more of the methodologies of functions described herein. For example, software 622 may store instructions to conduct a payment transaction. Software 622 may also reside, completely or at least partially, within main memory 604 and/or within processing device 602 during execution thereof by computer system 600; main memory 604 and processing device 602 also constituting machine-readable storage media. Software 622 may further be transmitted or received over a network 620 via network interface device 608.

Machine-readable storage medium 628 may also be used to store instructions to conduct a payment transaction. While machine-readable storage medium 628 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of claims, which in themselves recite only those features regarded as the invention.

We claim:

1. A computer-implemented method of conducting a payment transaction, said method comprising:
receiving, at a programmed computer, an indication to submit payment for a principal amount owed to a merchant;
identifying, at said programmed computer, a consumer rate and a merchant rate for calculating a platform fee owed to a platform operator, said platform operator brokering payment for said principal amount owed to said merchant;
generating, at said programmed computer, a first transaction part representative of said principal amount owed and a second transaction part representative of said platform fee owed; and
transmitting, using said programmed computer, said first transaction part and said second transaction part to a payment gateway to process said payment transaction.

2. The method of claim 1, wherein said consumer rate and said merchant rate are identified based on a selected payment method.

3. The method of claim 2, wherein said payment method is a credit card, a debit card, a pre-paid card, a charge card or an ACH transfer.

4. The method of claim 1, wherein said consumer rate identified is not equal to said merchant rate identified.

5. The method of claim 1, wherein said consumer rate identified is equal to said merchant rate identified.

6. The method of claim 1, wherein said consumer rate and said merchant rate are retrieved from a pre-defined rate table.

7. The method of claim 1, further comprising determining whether a cover value and a subsidy value are provided by said merchant.

8. The method of claim 7, wherein said platform fee is calculated based at least in part on said cover value and said subsidy value provided by said merchant.

9. The method of claim 7, wherein said cover value is a maximum monetary amount on which said merchant is willing to cover said platform fee.

10. The method of claim 7, wherein said subsidy value is a percentage rate said merchant is willing to pay for accepting said selected payment method.

11. The method of claim 7, wherein said platform fee is comprised of a cover amount, a subsidy amount and a consumer fee amount.

12. The method of claim 11, wherein said cover amount is calculated by multiplying said cover value provided by said merchant with said merchant rate.

13. The method of claim 11, wherein said subsidy amount is calculated by determining a difference between said principal amount and said cover value provided by said merchant, and multiplying said difference with said subsidy value provided by said merchant.

14. The method of claim 11, wherein said consumer fee amount is calculated by determining a first value representative of a difference between said principal amount and said cover value provided by said merchant, determining a second value representative of a difference between said consumer rate and said subsidy value provided by said merchant, and multiplying said first value with said second value.

15. The method of claim 11, wherein said platform fee amount is said consumer fee amount when said cover amount and said subsidy amount are zero.

16. The method of claim 1, wherein said first transaction part is received at said payment gateway interfacing with a merchant account, said principal amount owed being credited to said merchant account.

17. The method of claim 1, wherein said second transaction part is received at said payment gateway interfacing with a platform operator account, said platform fee owed being credited to said platform operator account.

18. The method of claim 1, wherein a failure associated with processing said second transaction results in a rollback of said first transaction, said failure resulting in cancellation of said payment transaction.

19. A computer system for conducting a payment transaction, said computer system comprising:
a memory; and
a processing device communicatively coupled to said memory, said processing device configured to:
receive an indication to submit payment for a principal amount owed to a merchant;
identify a consumer rate and a merchant rate for calculating a platform fee owed to a platform operator, said platform operator brokering payment for said principal amount owed to said merchant;
generate a first transaction part representative of said principal amount owed and a second transaction part representative of said platform fee owed; and
transmit said first transaction part and said second transaction part to a payment gateway to process said payment transaction.

20. A non-transitory computer-readable storage medium programmed to include instructions that, when executed by a processing device, cause said processing device to perform a method of conducting a payment transaction, said method comprising:
receiving an indication to submit payment for a principal amount owed to a merchant;
identifying a consumer rate and a merchant rate for calculating a platform fee owed to a platform operator, said platform operator brokering payment for said principal amount owed to said merchant;
generating a first transaction part representative of said principal amount owed and a second transaction part representative of said platform fee owed; and
transmitting said first transaction part and said second transaction part to a payment gateway to process said payment transaction.
